(19) United States
(12) Patent Application Publication
(10) Pub. No.: US 2022/0172051 A1
(43) Pub. Date: Jun. 2, 2022

(54) CONVOLUTION NEURAL NETWORK, METHOD AND DEVICE FOR OPTIMIZING OPERATION OF CONVOLUTION NERUAL NETWORK, ELECTRONIC DEVICE USING METHOD, AND NON-TRANSITORY STORAGE MEDIUM

(71) Applicant: HON HAI PRECISION INDUSTRY CO., LTD., New Taipei (TW)

(72) Inventors: REN-SHAN YI, New Taipei (TW); NIEN-FENG YAO, New Taipei (TW); HSUAN-CHIH HUANG, New Taipei (TW)

(21) Appl. No.: 17/533,349

(22) Filed: Nov. 23, 2021

(30) Foreign Application Priority Data
Nov. 30, 2020 (CN) 202011381083.5

(51) Int. Cl. G06N 3/08; G06K 9/62; G06F 9/30

(52) U.S. Cl. CPC G06N 3/08; G06F 9/3001; G06F 9/30036; G06K 9/6256

(57) ABSTRACT

A method for optimizing operation of convolution neural network outputs an input matrix of an input image. The method further slides on the input matrix according to preset convolution kernels to perform dot products to output first output matrixes on a convolution computing layer. Nonlinear mapping of the first output matrixes is performed according to a preset activation functions on an activation layer to output a second output matrixes. The method does not perform bias operations on the convolution computing layer. The results of the dot products performed on the convolution computing layer are output to the activation layer and bias operations are performed on the activation layer. The method reduces amount of calculation whilst not reducing accuracy of processing. An electronic device, a convolution neural network, and a non-transitory storage medium are also disclosed.

### FIELD

The subject matter herein generally relates to neural network technology, particularly to a convolution neural network, a method and a device for optimizing operation of convolution neural network, an electronic device applying the method, and a non-transitory storage medium.

### BACKGROUND

A convolution neural network (CNN) is a representative neural network in the field of deep learning. The convolution neural network can be applied on one or more fields, for example, voice recognition, image processing, image recognition, and so on. In a common standard image annotation set in academic sectors, the convolution neural network is widely applied, for example, extracting and classifying image features, object detection, scene identifying, and so on.

Before using the convolution neural network, the convolution neural network model must be firstly trained. A hierarchical structure of the convolution neural network includes a data input layer, a convolution computing layer, an activation layer, a pooling layer, and a fully connected layer. Training of a CNN model is usually implemented in a manner as follows.

At first, model parameters of the CNN model to be trained are initialized, the model parameters including initial convolution kernels of the respective convolution computing layer, initial bias matrixes of the respective convolution computing layer, and an initial weight matrix and an initial bias vector of a fully connected layer. Then, on the input layer of the data, a number of training images are selected from a training image set, and an area to be processed is acquired from each of the training images. The area to be processed corresponding to each of the training images is input into the CNN model to be trained. Next, on each convolution computing layer, convolution operation is performed on each area to be processed by using the initial convolution kernel and initial bias matrix of each convolution layer. On each activation layer, an activation function performs nonlinear mapping on a result of the convolution operation, to obtain an image of features of each area to be processed. Then, each image of features is processed to obtain classification probability of each area to be processed by using the initial weight matrix and initial bias vector of the fully connected layer.

Then, a classification error is calculated according to initial classification and the classification probability of each of the training images. A mean of the classification errors is calculated according to the classification errors of all the training images. Then, the model parameters of the CNN model to be trained are regulated by using the mean of the classification errors. Then, the abovementioned steps are iterated for a specified number of times by using the regulated model parameters and the respective training images. Finally, model parameters obtained when the number of iterations reaches the specified number of times are determined as being the model parameters of the trained CNN model.

In a trained CNN model, hundreds or even thousands of parameters may exist. The parameters may include weighting parameters, and bias parameters of each convolution layer in each hierarchy of the CNN model. The parameters may also include parameters of image of features of each convolution layer. The large number and variety of the parameters and a large amount of the data, a great deal of storage and computing resources may be consumed, whether during training or during computing using the trained CNN model.

A complexity of the CNN can be reduced without reducing accuracy of the CNN, by quantizing the parameters of the CNN. Quantizing is the process of mapping an input from a set of original value ranges to another set of object value ranges via some mathematical transformation, for example, table searching operation, shift operation, truncation operation, or the like. Multiple linear transformations can be employed to complete the transformation.

### SUMMARY

An embodiment of the present application provides a convolution neural network, a method and a device for optimizing operation of convolution neural network, an electronic device using method, and a non-transitory storage medium, which retains accuracy while reducing the number of calculations.

An embodiment of the present application provides a method for optimizing the operation of the convolution neural network. The method outputs an input matrix of an input image. Where the input matrix includes a piece of data, each of the data in the first matrix is an image data of the input image. The method slides on the input matrix according to preset convolution kernels to perform dot products to output one or more first output matrixes on a convolution computing layer. Each of the first output matrixes comprises feature data of features of the input image. The method performs nonlinear mapping on the one or more first output matrixes according to one or more preset activation functions on an activation layer, to output one or more second output matrixes. Each of the preset activation functions is configured to sift feature values of the feature data in one corresponding first output matrix according to a corresponding preset bias value of the convolution neural network, to map features which satisfy a preset condition onto the second output matrix according to the preset bias value. Each second output matrix includes data sifted from the feature data.

According to some embodiments of the present application, the method further includes, obtaining, for any one convolution kernel of the convolution computing layer, a preset bias value corresponding to the convolution kernel. The method further includes constructing a preset activation function for each of the convolution kernels according to the corresponding preset bias value.

According to some embodiments of the present application, the method obtains an original activation function and a threshold corresponding to the original activation function, where the threshold is configured to sift the feature data. The method constructs new thresholds according to the preset bias values and the threshold, and constructs new mapping values according to the preset bias values and the mapping values of the original activation function. The method constructs the preset activation functions according to the new thresholds and the new mapping values.

According to some embodiments of the present application, the method determines, for any one value in each of the first output matrixes, whether the value is greater than a corresponding new threshold. The method further includes mapping the value to be a total of the value and a corresponding preset bias value if the value is greater than the corresponding new threshold. The method further includes mapping the value to be a smaller value if the value is less than or equal to the corresponding new threshold, where the smaller value comprises zero.

According to some embodiments of the present application, the original activation function includes a Relu activation function. The Relu activation function includes f(x)=max (0, x). Where the threshold is zero, x is a feature value of the feature data, and f(x) is the mapping value.

According to some embodiments of the present application, the input matrix includes the matrix output from a previous network of the convolution neural network. The previous network includes an input layer, a convolution computing layer, an activation layer, or a pooling layer.

An embodiment of the present application provides a convolution neural network. The convolution neural network includes an input layer, a convolution computing layer, an activation layer, and an output layer. The input layer is configured to output an input matrix of an input image, where the input matrix comprises a plurality of data, each of the data in the first matrix is an image data of the input image. The convolution computing layer is configured to slide on the input matrix according to preset convolution kernels to perform dot products to output one or more first output matrixes. Each of the first output matrixes includes feature data of features of the input image. The activation layer is configured to perform nonlinear mapping on the one or more first output matrixes according to one or more preset activation functions, to output one or more second output matrixes. Each preset activation function sifts the values of the features of the feature data in one corresponding first output matrix according to a corresponding preset bias value of the convolution neural network, to map features which are able to satisfy a preset condition, to the second output matrix according to the preset bias value. Each of the second output matrix includes data sifted from the feature data. The output layer is configured to output an operation result of the convolution neural network.

An embodiment of the present application also provides an electronic device. The electronic device includes a storage device, and at least one processor. The storage device stores one or more programs, which when executed by the at least one processor, cause the at least one processor to output an input matrix of an input image, slide on the input matrix according to preset convolution kernels to perform dot products to output one or more first output matrixes on a convolution computing layer, and perform nonlinear mapping on the one or more first output matrixes according to one or more preset activation functions on an activation layer, to output one or more second output matrixes. Each of the data in the first matrix is an image data of the input image. Each of the first output matrixes includes feature data of features of the input image. Each preset activation function sifts feature values of the feature data in one corresponding first output matrix according to a corresponding preset bias value of the convolution neural network, to map the features which satisfy a preset condition to the second output matrix according to the preset bias value. Each second output matrix includes data sifted from the feature data.

An embodiment of the present application also provides a non-transitory storage unit. The non-transitory storage medium stores a set of commands, the commands being executed by at least one processor of an electronic device causes the at least one processor to output an input matrix of an input image, slide on the input matrix according to preset convolution kernels to perform dot products to output one or more first output matrixes on a convolution computing layer, and perform nonlinear mapping on the one or more first output matrixes according to one or more preset activation functions on an activation layer to output one or more second output matrixes. Each of the data in the first matrix is an image data of the input image. Each first output matrix includes feature data of feature of the input image. Each of the preset activation functions is configured to perform a sifting of feature values of the feature data in one corresponding first output matrix according to a corresponding preset bias value of the convolution neural network, and map the features which satisfy a preset condition to the second output matrix according to the preset bias value. Each of the second output matrix includes data sifted from the feature data.

The disclosure provides a method for optimizing the operation of the convolution neural network, a device for optimizing the operation of the convolution neural network, an electronic device and storage medium. In the method, the input matrix of the input image is obtained. The method slides on the input matrix according to the preset convolution kernels and performs dot products to output one or more first output matrixes on the convolution computing layer. On the activation layer, the one or more first output matrixes receives a nonlinear mapping according to one or more preset activation functions, to output one or more second output matrixes. Each preset activation function is configured to perform a sifting of features of one corresponding first output matrix according to a corresponding preset bias value of the convolution neural network, to map the features which satisfy a preset condition to the second output matrix according to the preset bias value. Bias operations are not carried out on the convolution computing layer. The results of the dot products performed on the convolution computing layer are output to the activation layer and bias operations are carried out on the activation layer. Thus, amounts of calculation are reduced but same operation accuracy is maintained.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is a structure view of an embodiment of a convolution neural network.

FIG. 2 is an operation view of an embodiment of a convolution computing layer.

FIG. 3 is a view showing a bias operation.

FIG. 4 is a view showing an activation operation.

FIG. 5 is a block diagram of an embodiment of an electronic device.

FIG. 6 is a flowchart of an embodiment of a method for optimizing operation of convolution neural network.

FIG. 7 is a flowchart describing a process for constructing an activation function.

FIG. 8 is a view of an embodiment of a Relu function.

FIG. 9 is a view of an embodiment of a preset activation function.

FIG. 10 is a view of an embodiment of dot products.

FIG. 11 is a flowchart describing a process for performing a nonlinear mapping.

FIG. 12 is structure view of another embodiment of a convolution neural network.

FIG. 13 is a block diagram of an embodiment of a device for optimizing the operation of the convolution neural network.

### DETAILED DESCRIPTION

Each neural node in the neural network receives an output value from previous layer of neurons and passes same as input to a next layer. The neural node in the input layer can pass the input attribution value to the next layer, for example, a hidden layer or an output layer.

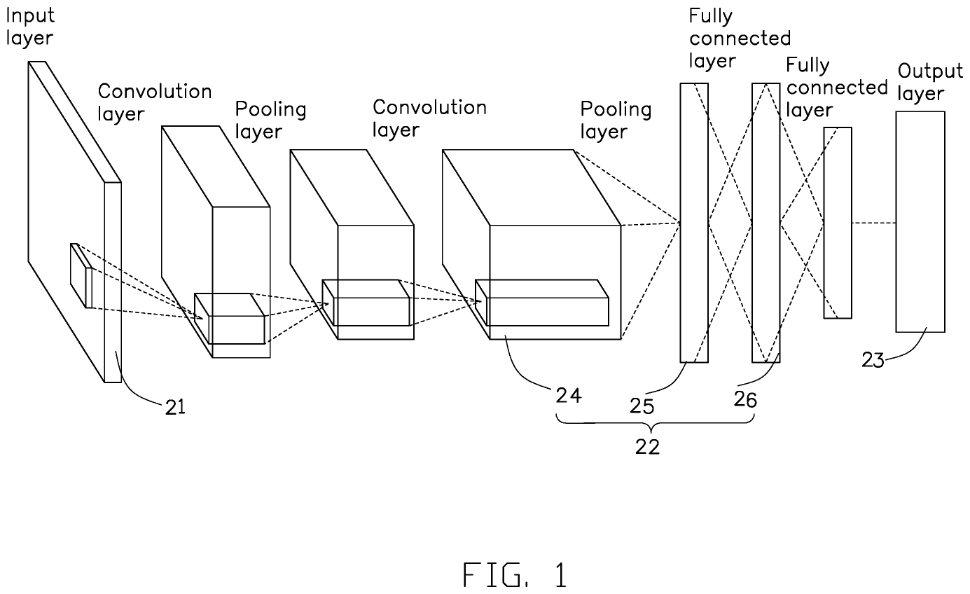

Referring to FIG. 1, CNN is a class of feedforward neural networks capable of perform convolution computing and having a deep construct. The CNN has applications in voice recognition, image processing, image recognition, and so on. The CNN usually consists of an input layer 21, hidden layers 22, and an output layer 23. Each hidden layer 22 include a convolution layer 24, a pooling layer 25, and a fully connected layer 26. Each convolution layer 24 includes a convolution computing layer and an activation layer.

The input layer 21 performs preprocessing on input image data or input voice data. The preprocessing includes mean removal, mean normalization, a principal component analysis (PCA), and a whitening. For example, in a preprocessing on the input image data in the neural network, the feature of the input image data is large data, so the result of the convolution computing is large. During outputting via the activation function, if an amount of change of the data of the corresponding position is small, it is easy to fit. Thus, mean removal is needed on the input image data. During mean removal, the dimension mean is removed from each dimension, so that each dimension of the input image data is centered on zero. Mean normalization can include normalization and standardization. Mean normalization can adjust a scale of the feature values in each input image data so as to be in a same range, to be convenient for finding optimal solutions. PCA is a technique for reducing the dimensionality of data, via removing the dimensionality with fewer information, while preserving only the significant feature information. PCA can be configured to extract feature, compress data, remove noise, reduce dimensionality, and so on. Whitening can remove correlations between data and uniformization variance. In an image, there is a high level of correlation between adjacent pixels, thus when the image is used in training, a large amount of input data is redundant, whitening cleans the redundancy.

In the embodiment, the input layer 21 is configured to receive an input image input by a user. The input layer 21 transforms the input image and outputs an input matrix. Each data in the input matrix is data as the image of the input image. In detail, on the input layer 21, a gray processing is performed on the input image. A digital array is used to represent an image. Each pixel that represents an image has a pixel value which describes how bright that pixel is. For example, the input image is an image of size 7×7×3, where 7×7 are the pixels comprising the image, 3 is three channels, respectively, red, green, and blue, comprising the image. Thus, the image of size 7×7×3 corresponds to three times 7×7 matrixes.

The convolution computing layer is configured to extract features from the input matrix output from the input layer 21. During the convolution operation, a matrix with a size of F×F is chosen, namely an f×f convolution kernel is chosen. The convolution kernel can be also a filter. The size of the matrix is receptive field. A depth d of the convolution kernel is the same as a depth of the input image, the depth d of the input image being the channels of the input image. Thus, a convolution kernel with a size of F*F*d is obtained, namely d matrixes each with a size of F×F are obtained. Different models may have different numbers of convolution kernels. In the embodiment, the number of the convolution kernels in a model is k, each convolution kernel is Wi, and each convolution kernel includes d matrixes each with a size of F×F.

The peripheral pixels (for example, corners and the edges) are used much less than those in the middle. The input matrix shrinks every time a convolution operation is performed, namely a size of an output matrix resulting after convolution operation is less than a size of the input matrix. Thus, there is a process of adding layers of zeros to the border of the input matrix, and the number of layers of zeros added to the border of the input matrix is p. For example, when P=1, one layer of zero is padded to the border of the input matrix. The convolutional kernel slides on the input matrix to perform convolution operation. The number of rows and columns traversed per slide is S For example, when S=2, the number of rows or columns traversed per slide by the convolutional kernel slide on the input matrix is two.

Operation of a convolution computing layer is usually implemented as follows.

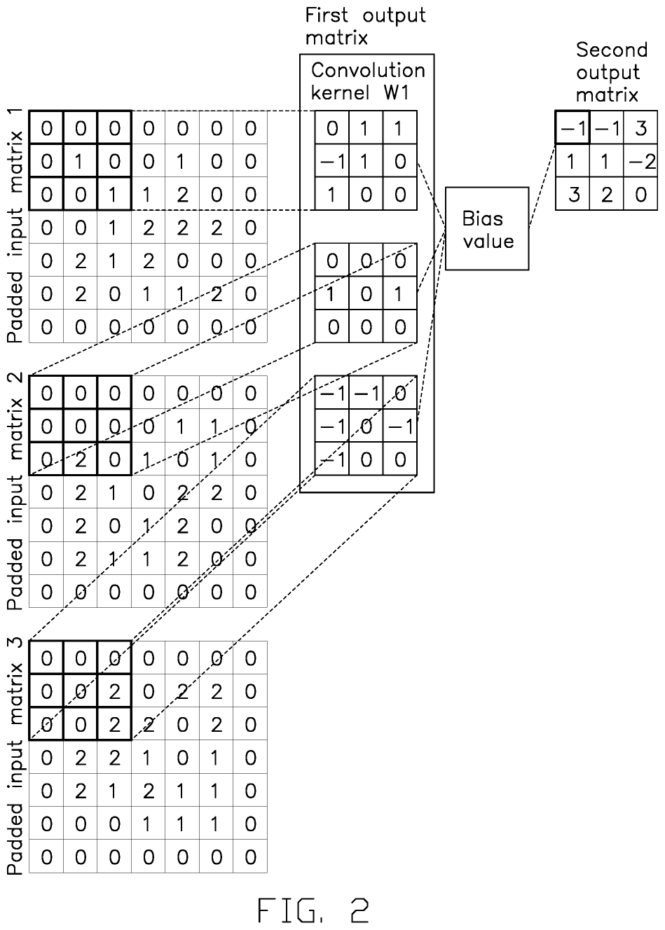

Referring to FIG. 2, for example, the input matrix after padding is 7*7*3, the number of layers of zeros added to the border of the input matrix is P =1, the number of the convolution kernel is k=1, a size of each filter is 3*3*3 , namely F=3, the number of rows or columns traversed per slide is S=2, and the bias value is b=1.

In FIG. 2, each pixel value of each image block of the input image is multiplied with the kernel value of the matrix of the convolution kernel it overlaps with, to obtain a multiplied value, where a size of each image block is the same as a size of the convolution kernel. All of the multiplied values are summed. The summed value and the bias value corresponding to the convolution kernel is added to obtain feature data in a feature map corresponding to the image block. A position of the feature data in the feature map, namely in the output matrix, corresponds to a position of the image block in the input image.

In detail, the method starts with a receptive field size of 3*3 at the upper-left corner of the padded input matrix. Each depth of the padded input matrix corresponds to one depth of the convolution kernel. Perform dot products between the convolution kernels and local regions of the padded input matrix, and add the bias value to obtain a first element in the output matrix. The padded input matrix 1 corresponds to a first depth of the padded input matrix, for example corresponds to green channel of the input image. The padded input matrix 2 corresponds to a second depth of the padded input matrix, for example it corresponds to red channel of the input image. The padded input matrix 3 corresponds to a third depth of the padded input matrix, for example to blue channel of the input image. In detail:

$$The padded input matrix 1 \text{:} r 1 = 0 * 0 + 0 * 1 + 0 * 1 + 0 * ( - 1 ) + 1 * 0 + 0 * 0 + 0 * 1 + 0 * 0 + 1 * 0 = 0.$$

$$The padded input matrix 2 \text{:} r 2 = 0 * 0 + 0 * 0 + 0 * 0 + 0 * 1 + 0 * 0 + 0 * 1 + 0 * 0 + 2 * 0 + 0 * 0 = 0.$$

$$The padded input matrix 3 \text{:} r 3 = 0 * ( - 1 ) + 0 * ( - 1 ) + 0 * 0 + 0 * 0 + 0 * 0 + 2 * ( - 1 ) + 0 * ( - 1 ) + 0 * 0 + 2 * 0 = - 2 .$$

A first element in the output matrix output 11=r1+r2+r3+b=0 30 0+(−2)+(1)=−1

After obtaining a first element of the output matrix, slide it over all locations, downward and to the right. After computing the first output matrix, if the convolution computing layer has multiple convolution kernels, continuous computing using a next convolution kernel to output another output matrix is performed until all of the convolution kernels are computed.

In a conventional computing of the cross-correlation, the bias operation will be performed on the convolution computing layer. The dot products are performed in the convolution kernel to obtain feature data of the image, and then the bias value corresponding to the convolution kernel is added to the sum of products. In the convolution neural network, there are many layers of convolution computing layers. Each convolution computing layer may include many convolution kernels. For one convolution computing layer, the calculation amount of the bias operation is F*F*k, where F is a size of the output matrix, and k is the number of the convolution kernel in the convolution computing layer. When the number of convolution kernels is greater and the size of the output feature map is larger, for one convolution computing layer, the bias calculation amount is larger. For the entire convolution neural network, the bias calculation amount is much larger.

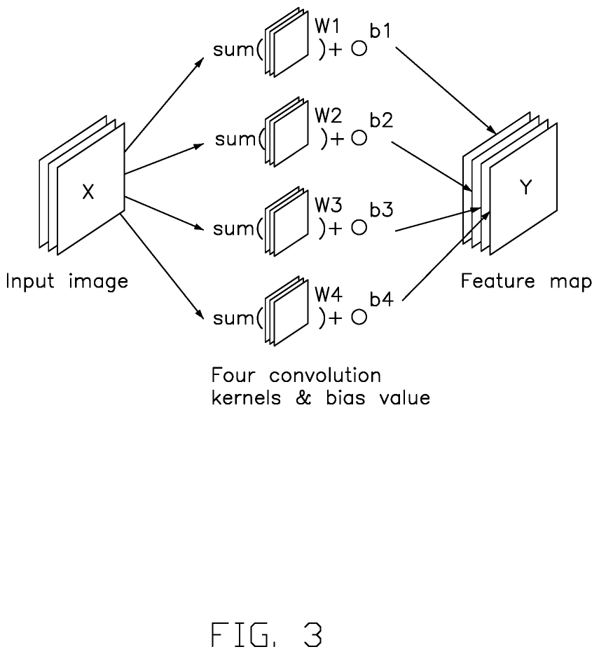

Referring to FIG. 3, during a conventional convolution operation, for example, the input image is an input matrix of size 42*42*3. For example, the ith convolution computing layer has four convolution kernels, respectively, a convolution kernel W1, a convolution kernel W2, a convolution kernel W3, and a convolution kernel W4. For example, b1, b2, b3, and b4 are respectively preset values corresponding to the convolution kernel W1, a preset value corresponding to the convolution kernel W2, a preset value corresponding to the convolution kernel W3, and a preset value corresponding to the convolution kernel W4. For example, padding=“same”, namely, the output matrixes each will have the same size as the input matrix, thus the size of the output matrix is 42*42. Thus, the stride, namely S, on the convolution kernel is one. After dot products are performed between the convolution kernel and the input matrix, the preset bias values b1, b2, b3, and b4 are respectively added, to output a feature map of the input image. The number of the bias operations is 42*42*4. The result of the bias operations will be further calculated via an activation function in the activation layer.

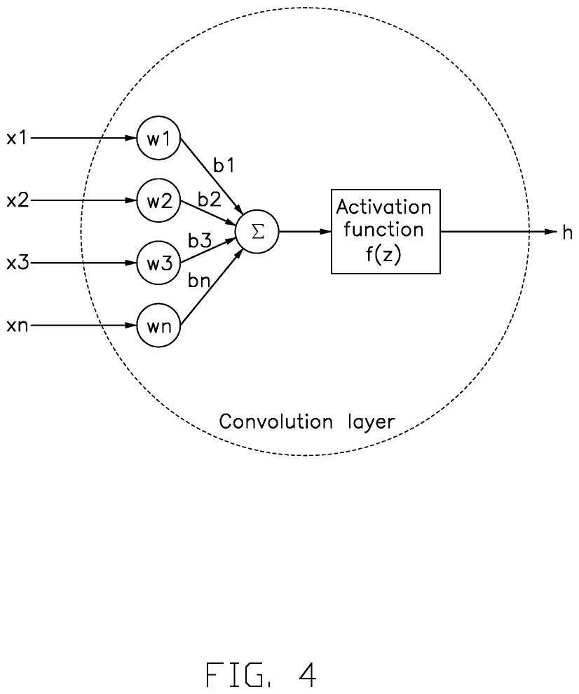

The activation layer performs a nonlinear mapping on the feature data of the feature map output from the previous convolution computing layer via the activation function. Referring to FIG. 4, the convolution layer 24 includes the convolution computing layer and the activation layer. The convolution computing layer and the activation layer are adjacent to each other. x1, x2, x3, . . . , and xn are respectively image data of the input matrix and w1, w2, w3, . . . , and wn are respectively weightings of the convolution kernels. After performing dot products between all the convolution kernels in the convolution computing layer and the image data of the input matrix, then preset bias values b1, b2, b3, and bn are respectively added. The added data is mapped in a nonlinear way by the activation function to obtain a sifted feature data h.

A pooling layer 25 is a new layer added between two continuous convolutional layers 24. The pooling layer 25 is configured for compressing the special size of data and parameters as well as minimizing the likelihood of overfitting. When the input data is the image data, the pooling layer 25 is configured to compress the image. Two common pooling methods are average pooling and max pooling.

Fully Connected layers 26 are configured to combine all features in the previous different layers and pass the final image data to the SoftMax classifier. Each node of each fully connected layer 26 is fully connected to all the nodes in the previous different layers, to combine the features extracted from previous different layers.

The output layer 23 is configured to output the final result of the convolution neural network. When being applied to image classification, the output layer 23 can be connected to the SoftMax classifier.

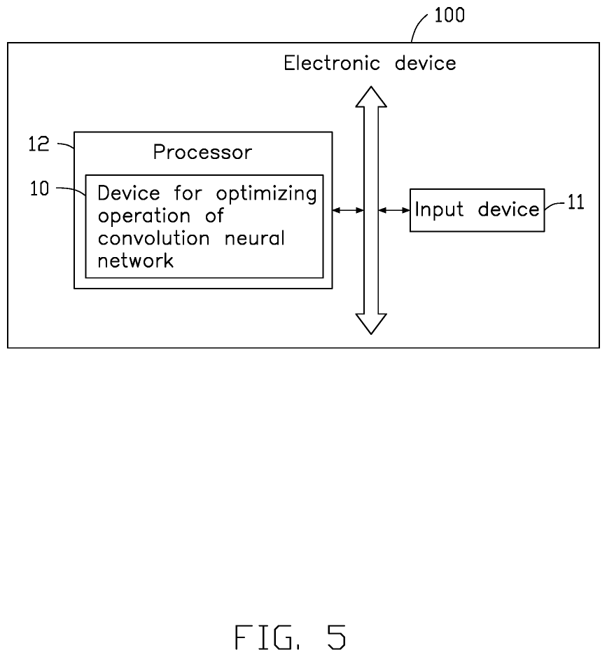

Referring to FIG. 5, a device for optimizing operation of convolution neural network 10 is run on an electronic device 100. The electronic device includes, but is not limited to, an input device 11 and at least one processor 12. The above mentioned elements are coupled by a bus or buses.

It should be noted that the electronic device 100 shown in FIG. 5 is merely an example. In other embodiments, the electronic device 100 may also have more or fewer elements than FIG. 5 or may also perform arrangement of different configurations on the architecture in FIG. 5. The electronic device 100 may include different IOT terminals or devices, for example a tablet PC, a laptop computer, an onboard computer, a desktop computer, and so on.

In one embodiment, the input device 11 is an input interface of the electronic device 100. The input device 11 is configured to receive input data. The device for optimizing the operation of the convolution neural network 10 is logically coupled to the input device 11. Thus, the electronic device 100 can process the data from the input device 11 via the device for optimizing the operation of the convolution neural network 10. The processor 12 is coupled to the input device 11, to process the input data using the convolution neural network.

In the embodiment, in the conventional convolution neural network operation method, the convolution layer performs convolution operation on the input image as well as performing bias operations. Where each feature data of the input image in the output matrix is obtained by performing convolution operation, bias operations on a corresponding preset bias value corresponding to the convolution kernel are performed. A method for optimizing operation of convolution neural network is provided. The method performs the convolution operation on the input image on the convolution computing layer, but does not perform bias operations on the convolution computing layer. The method performs dot products on the convolution kernels to obtain an output matrix, and outputs the output matrix to the activation layer. Namely, during the extraction of features from the input image, the method passes the features extracted from the image data to the activation layer, the method does not use the preset bias value to adjust the feature data. For the feature data of each output matrix, the method performs only one bias operation on the activation layer, and the accuracy of the operation result is the same as the conventional method. However, the amount of calculation is reduced. Compared to adding a quantizing step to reduce the calculation amount, the operation steps of the method are not added to, but the amount of bias operation is reduced.

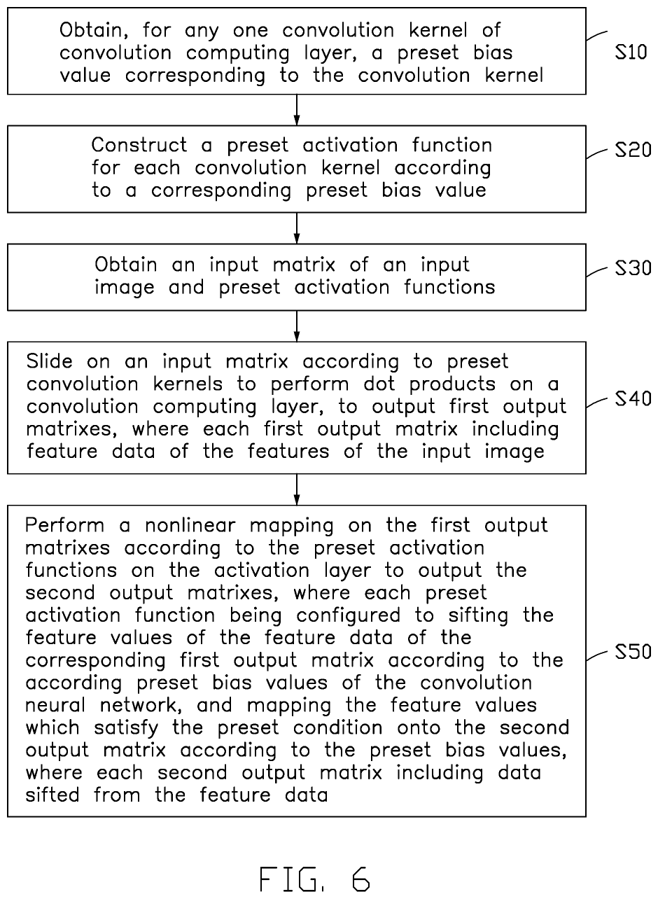

Referring to FIG. 6, FIG. 6 is a flowchart of an embodiment of a method for optimizing the operation of the convolution neural network. The method for optimizing the operation of the convolution neural network is applied on the device for optimizing the operation of the convolution neural network. The method for optimizing the operation of the convolution neural network includes:

At step S10, obtaining, for any one convolution kernel of the convolution computing layer, a preset bias value corresponding to the convolution kernel.

In the embodiment, the bias values are important parameters in the convolution neural network. Each convolution kernel corresponds to one preset bias value. The preset bias values can be same or different, and can be set according to the need. The preset bias values can be used to perform bias operations on the image data of the input image. For example, as shown in the FIG. 3, W1, W2, W3, and W4 each is a convolution kernel. b1, b2, b3, and b4 are respectively a preset value corresponding to the convolution kernel W1, a preset value corresponding to the convolution kernel W2, a preset value corresponding to the convolution kernel W3, and a preset value corresponding to the convolution kernel W4.

At step S20, constructing a preset activation function for each convolution kernel according to the corresponding preset bias value.

In the embodiment, after extracting feature from the input image to obtain the feature data of the input image, the preset activation function can activate the feature data, namely sift the feature data.

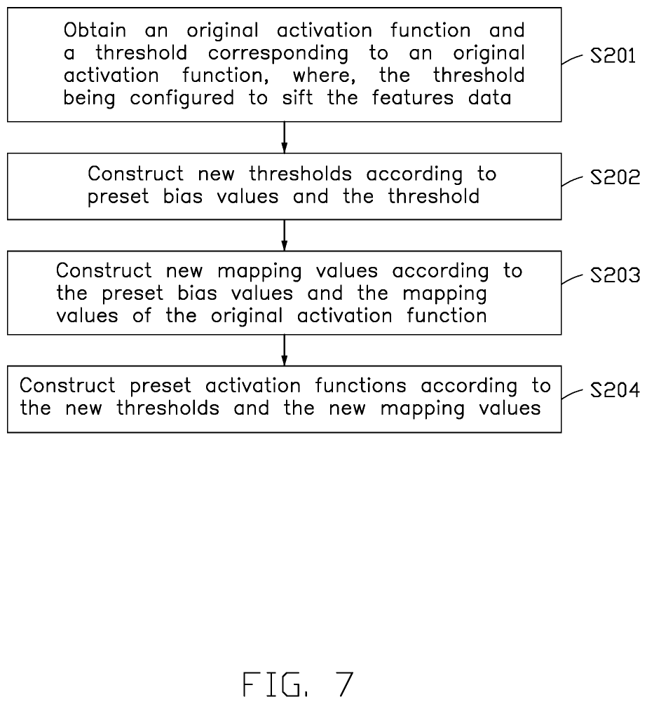

According to some embodiments, referring to FIG. 7, the constructing of a preset activation function for each convolution computing layer according to the corresponding preset bias value includes a step S201, a step S202, a step S203, and a step S204.

The step S201 includes obtaining an original activation function and a threshold corresponding to the original activation function. Where, the threshold is configured to sift the feature data.

The step S202 includes constructing new thresholds according to the preset bias values and the threshold.

The step S203 includes constructing new mapping values according to the preset bias values and the mapping values of the original activation function.

The step S204 includes constructing the preset activation functions according to the new thresholds and the new mapping values.

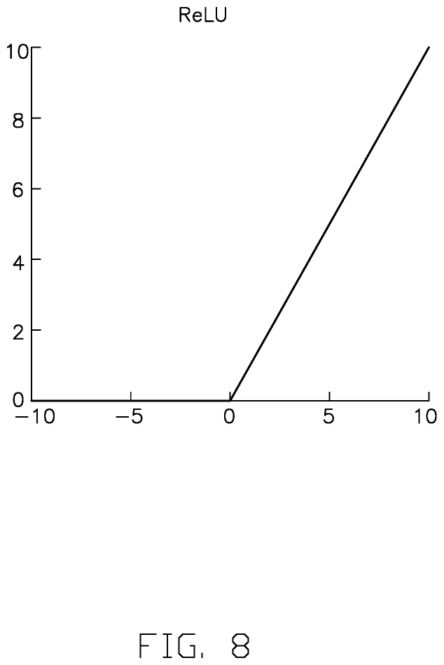

According to some embodiments, the original activation function includes a Relu activation function. Referring to FIG. 8, the original Relu activation function can be f(x)=max (0, x). Where the threshold is zero,×is a feature value of the feature data of the first output matrix output from the convolution computing layer. If the feature value x is greater than the threshold zero, the activation function f(x)=x. If the feature value x is less than the threshold zero, the activation function f(x)=0. Namely, the Relu activation function only activates the feature value which is greater than the threshold zero, and reserves the feature value. The feature value which is less than or equal to the threshold zero is not reserved.

In the embodiment, taking the Relu activation function as an example of the original activation function. A logic of constructing the new threshold according to the preset bias value and the threshold is that, a total of the preset bias value bias and the feature value x is the threshold zero of the original activation function. Thus, the new threshold is a result of subtraction of the preset bias value from the threshold zero of the original activation function, namely, −bias. The sifting condition of the new threshold on the convolution computing layer is consistent with the sifting condition of the threshold of the original activation function on the convolution computing layer. Where the new threshold is constructed on the activation layer. The constructing of new mapping values according to the preset bias values and the mapping values of the original activation function is that, if the feature value x is greater than the new threshold (−bias), the new mapping value of the activation function is determined by f(x)=x+a, where a is the preset bias value. Namely, if the feature value x is greater than the new threshold (−bias), the new mapping value of the activation function is a total of the x and the preset bias value. And if the feature value x is less than or equal to the new threshold (−bias)), the new mapping value of the activation function is f(x)=0. Thus, the preset activation functions can be, if the feature value x is less than or equal to the new threshold (−bias), the new mapping value is f(x)=0, if the feature value x is greater than the new threshold (−bias), the new mapping value of the activation function is f(x)=x+bias, where the bias is the preset bias value corresponding to each convolution kernel.

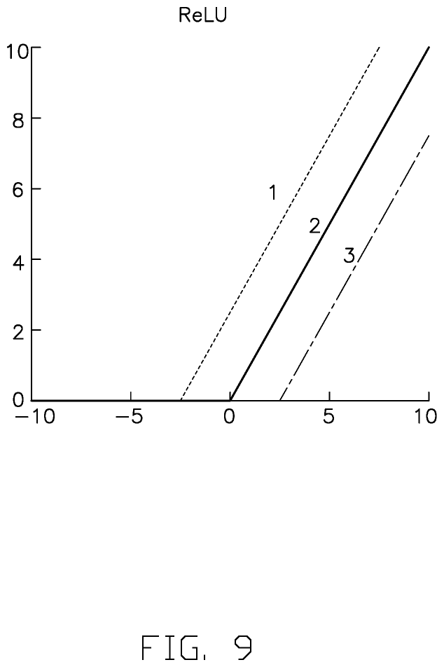

Referring to FIG. 9, the preset activation functions can be a dash line 1 and a dash dot line 3. The preset activation function is constructed from the original activation function. The solid line 2 is the original activation function.

In the embodiment, according to a different of the original activation function, the constructed preset activation function is different. The original activation function may include other activation functions which satisfies the above constructing condition, the disclosure is not limited to herein. In the embodiment, according to a different of the preset bias value corresponding to the convolution kernel, the constructed preset activation function is different, the disclosure is not limited to herein.

Referring to FIG. 6, at step S30, obtaining an input matrix of the input image and the preset activation functions.

According to some embodiments, the input matrix includes the matrix output from a previous network of the convolution neural network. Where the previous network includes an input layer, a convolution computing layer, an activation layer, or a pooling layer.

In the embodiment, each data in the input matrix is the image data of the input image. When the previous network is the input layer, each data in the input matrix is the original image data of the input image. When the previous network is the convolution computing layer, each data in the input matrix is the image data comprising the feature of the input image obtained by extracting feature from the input image. When the previous network is the activation layer, each data in the input matrix is the image data activated and sifted from the feature data. When the previous network is the pooling layer, each data in the input matrix is the image data compressed from the activated and sifted feature data.

In the embodiment, the convolution neural network may include a number of convolution computing layers, a number of activation layers, and so on. For ith convolution computing layer, the input feature of the input image is a result output from (i−1)th convolution computing layer, and/or (i−1)th activation layer.

At step S40, sliding on the input matrix according to preset convolution kernels to perform dot products on the convolution computing layer, to output the first output matrixes, where each first output matrix including feature data of the features of the input image.

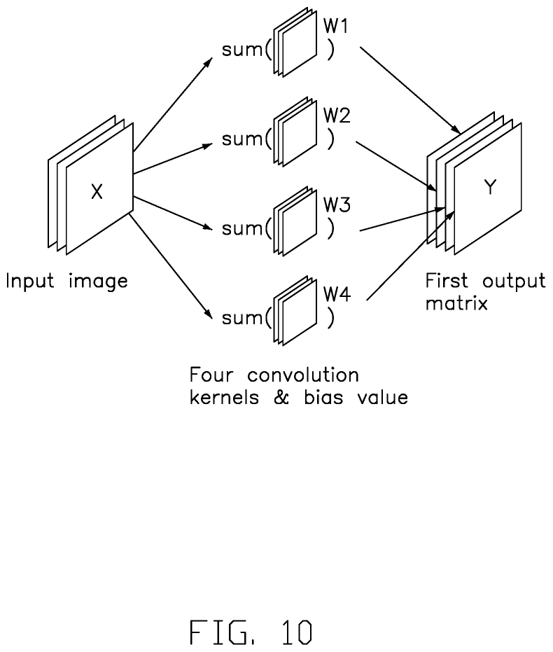

In the embodiment, referring to FIG. 10, after the convolution kernels performing dot products, the convolution computing layer outputs the first output matrix including feature data of the input image. Bias operations on the feature data of the input image are not performed on the convolution computing layer, but are performed on the activation layer. A dot product is a binary operation that takes two vectors in a range of a real number R and returns a real-valued scalar. For example, two vectors, respectively a=[a1, a2, . . . , an], and b=[b1, b2, . . . , bn]), a dot product of the two vectors can be defined as α*b=a1b1+α2b2+. . . +anbn.

At step S50, performing a nonlinear mapping on the first output matrixes according to the preset activation functions on the activation layer to output the second output matrixes, where each preset activation function being configured to sifting the feature values of the feature data of the corresponding first output matrix according to the according preset bias values of the convolution neural network, and mapping the feature values which satisfy the preset condition onto the second output matrix according to the preset bias values, where each second output matrix including data sifted from the feature data.

In the embodiment, each convolution computing layer sums the multiplied values of each the convolution kernel therein, and passes the summed value to the activation layer adjacent to the convolution computing layer to perform nonlinear mapping via the preset activation function. After extracting feature from the input image and outputting the first output matrixes on the convolution computing layer, the preset activation functions sift the feature data of features of the first output matrixes to output the second output matrixes.

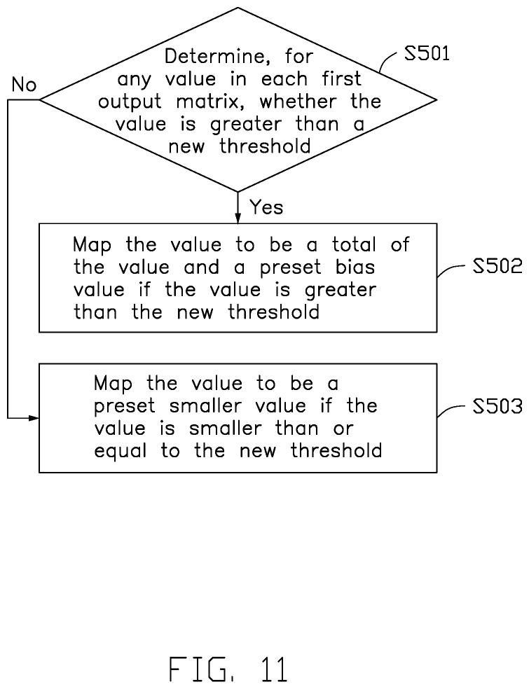

According to some embodiments, referring to FIG. 11, the performing of a nonlinear mapping on the first output matrixes according to the preset activation functions on the activation layer to output the second output matrixes includes a step S501, a step S502, and a step S503.

The step S501 includes, determining, for any value in each first output matrix, whether the value is greater than the new threshold.

The step S502 includes mapping the value to be a total of the value and the preset bias value if the value is greater than the new threshold.

In the embodiment, if the value of the feature data of one first output matrix is greater than the new threshold, mapping the value of the feature data to be a total of the original value of the feature data and the preset bias value, thus the feature data is activated.

The step S503 includes mapping the value to be a preset smaller value if the value is smaller than or equal to the new threshold. Where the preset smaller value includes zero. Thus, the feature data is not activated.

In the embodiment, if the value of the feature data of the first output matrix is less than or equal to the new threshold, mapping the value of the feature data to be the smaller value, thus the feature data is not activated.

In the embodiment, the bias operations are not performed on the convolution computing layer, but are performed on the activation layer using the preset activating function f(x)=max (0, x+bias). The result by using the preset activating function f(x) =max (0, x+bias) is the same as an activation value obtained via a conventional method. Where x is the feature value, and bias is the preset bias value, the new threshold value is the (−bias). If the feature value does not satisfy the sifting condition, the feature value is mapped to the preset smaller value zero. If the feature value satisfies the sifting condition, the feature value is mapped to a total of the feature value and the preset bias value. Taking the input matrix in the FIG. 3 as an example, for example, a probability that x is greater than the new threshold (−bias) is p, and a probability that x is less than or equal to the new threshold (−bias) is 1−p, where 0<=p<=1. If the feature value x is greater than the new threshold (−bias), thus f(x)=x+bias. If the feature value x is less than or equal to the new threshold (−bias), thus f(x)=0. The number of the bias operations will be: 4+p%*42*42*4. Thus, the bias operations with a number [(1−p)*42*42*4−4] will be saved. Where the number of the convolution kernels is 4. However, the output from the activation layer is not varied, thus the number of the bias operations can be reduced, but the accuracy of the convolution neural network is maintained. The amounts of calculation of the convolution neural network is accordingly reduced. The amounts of calculation of the image processing is accordingly reduced and an efficiency that the convolution neural network processes the image is improved accordingly.

It should be noted that, the method for optimizing the operation of the convolution neural network can be applied to a training process of the neural network, or can be applied to an operation process of the trained convolution neural network.

Referring to FIG. 12, FIG. 12 is structure view of the convolution neural network. The convolution neural network includes an input layer 01, a convolution computing layer 02, an activation layer 03, and an output layer 04.

The input layer 01 is configured to output the input matrix of the input image. Where, each data in the input matrix is an image data of the input image.

The convolution computing layer 02 is configured to obtain the input matrix of the input image, slide on the input matrix according to the preset convolution kernels, and perform dot products to output one or more first output matrixes, each first output matrix including feature data of feature of the input image.

The activation layer 03 is configured to perform nonlinear mapping on the one or more first output matrixes according to one or more preset activation functions, to output one or more second output matrixes. Where each preset activation function is configured to sift feature values of the feature data of one corresponding first output matrix according to a corresponding preset bias value of the convolution neural network, to map features which satisfy a preset condition onto the second output matrix according to the preset bias value. Where each second output matrix includes data sifted from the feature data.

The output layer 04 is configured to output an operation result of the convolution neural network.

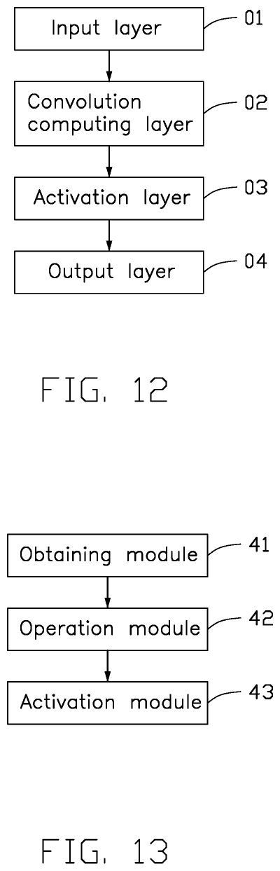

Referring to FIG. 13, FIG. 13 is a block diagram of an embodiment of a device for optimizing the operation of the convolution neural network. The device for optimizing the operation of the convolution neural network includes an obtaining module 41, an operation module 42, and an activation module 43.

The obtaining module 41 is configured to output the input matrix of the input image. Where, each data in the first matrix is an image data of the input image.

The operation module 42 is configured to obtain the input matrix of the input image, slide on the input matrix according to the preset convolution kernels, and perform dot products to output one or more first output matrixes, each first output matrix including feature data of features of the input image.

The activation module 43 is configured to perform nonlinear mapping on the one or more first output matrixes according to one or more preset activation functions, to output one or more second output matrixes. Where each preset activation function is configured to sift feature value of the feature data of one corresponding first output matrix according to a corresponding preset bias value of the convolution neural network, to map the features which satisfy a preset condition onto the second output matrix according to the preset bias value. Where each second output matrix includes data sifted from the feature data.

The disclosure provides a method for optimizing the operation of the convolution neural network, a device for optimizing the operation of the convolution neural network, an electronic device and storage medium. In the method, the input matrix of the input image is obtained. The method slides on the input matrix according to the preset convolution kernels and performs dot products to output one or more first output matrixes on the convolution computing layer. On the activation layer, the one or more first output matrixes are performed nonlinear mapping according to one or more preset activation functions, to output one or more second output matrixes. Each preset activation function is configured to sift features of one corresponding first output matrix according to a corresponding preset bias value of the convolution neural network, to map the features which satisfy a preset condition onto the second output matrix according to the preset bias value. The method does not perform bias operations on the convolution computing layer. The method outputs the results of the dot products performed on the convolution computing layer to the activation layer and performs bias operations on the activation layer. Thus, the method can retain accuracy while reducing amount of calculations.

In at least one embodiment, the at least one processor 12 can be one or more central processing units, or it can be one or more other universal processors, digital signal processors, application specific integrated circuits, field-programmable gate arrays, or other programmable logic devices, discrete gate or transistor logic, discrete hardware components, and so on. The universal processor can be a microprocessor or the at least one processor 12 can be any regular processor, or the like.

If the modules/units of the device for optimizing the operation of the convolution neural network 10 are implemented in the form of or by means of a software functional unit installed in independent or standalone product, all parts of the integrated modules/units of the storage unit may be stored in a computer-readable storage medium. One or more programs are used to control the related hardware to accomplish all parts of the methods of this disclosure. The one or more programs can be stored in a computer-readable storage medium. The one or more programs can accomplish the step of the exemplary method when executed by the at least one processor. The one or more stored programs can include program code. The program code can be in the form of source code, object code, executable code file, or in some intermediate form. The computer-readable storage medium may include any entity or device capable of recording and carrying the program codes, recording media, USB flash disk, mobile hard disk, disk, computer-readable storage medium, read-only memory, random access memory, electrical carrier signals, telecommunications signals, and software distribution package. The content stored in the computer-readable storage medium can be increased or decreased in accordance with legislative requirements and regulations of patent practice jurisdictions, for example, in some jurisdictions, legislation and patent practice stipulates that computer-readable storage medium does not include electrical carrier signals or telecommunications signals.

Division of the modules is only a logical function division, and other division manners may be adopted during practical implementation. Each function module in each embodiment of the present disclosure may be integrated into a processing module, each module may also exist independently and physically, and two or more than two modules may also be integrated into a module. The above-mentioned integrated module may be implemented in a form of hardware, and may also be implemented in forms of hardware and software function module.

In an alternative embodiment, the electronic device 100 further includes a storage unit. One or more programs stored in the storage unit and can be run on the at least one processor 12. The storage unit can be an inner storage unit of the electronic device 100, namely a built-in storage unit of the electronic device 100. In other embodiments, the storage unit can also be an external storage unit of the electronic device 100, namely a peripheral storage unit of the electronic device 100.

In some embodiments, the storage unit is configured to store program code and various data, for example store program code of the device for optimizing the operation of the convolution neural network 10 stored in the electronic device 100, and complete high-speed and automatic accessing of program or data during the operation of the electronic device 100.

The storage unit can include high-speed random access memory. The storage unit can further include non-transitory storage medium, such as hard disk, memory, plug-in hard disk, smart media card, secure digital, flash card, at least one disk storage device, flash memory, or other transitory storage medium.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for optimizing operation of convolution neural network comprising:
outputting an input matrix of an input image, where the input matrix comprising a plurality of data, each of the plurality of data being an image data of the input image;
sliding on the input matrix according to preset convolution kernels to perform dot products to output one or more first output matrixes on a convolution computing layer, each of the first output matrixes comprising feature data of features of the input image; and
performing nonlinear mapping on the one or more first output matrixes according to one or more preset activation functions on an activation layer to output one or more second output matrixes, where each of the preset activation functions being configured to sift feature values of the feature data in one corresponding first output matrix according to a corresponding preset bias value of the convolution neural network, to map the features which satisfy a preset condition onto the second output matrix according to the preset bias value, each of the second output matrix comprising data sifted from the feature data.

2. The method according to claim 1, wherein the method further comprises:
obtaining, for any one convolution kernel of the convolution computing layer, a preset bias value corresponding to the convolution kernel; and
constructing a preset activation function for each of the convolution kernels according to the corresponding preset bias value.

3. The method according to claim 2, wherein the constructing the preset activation function for each of the convolution kernels according to the corresponding preset bias value comprises:
obtaining an original activation function and a threshold corresponding to the original activation function, where the threshold being configured to sift the feature data;
constructing new thresholds according to the preset bias values and the threshold;
constructing new mapping values according to the preset bias values and mapping values of the original activation function; and
constructing the preset activation functions according to the new thresholds and the new mapping values.

4. The method according to claim 3, wherein the performing nonlinear mapping on the one or more first output matrixes according to one or more preset activation functions on an activation layer to output one or more second output matrixes comprises:
determining, for any one value in each of the first output matrixes, whether the value is greater than a corresponding new threshold;
mapping the value to be a total of the value and a corresponding preset bias value if the value is greater than the corresponding new threshold; and
mapping the value to be a smaller value if the value is less than or equal to the corresponding new threshold, where the smaller value comprising zero.

5. The method according to claim 3, wherein:
the original activation function comprises a Relu activation function, where the Relu activation function comprises f(x)=max (0, x), where the threshold being zero, x being a feature value of the feature data, and f(x) being the mapping value.

6. The method according to claim 1, wherein:
the input matrix comprises the matrix output from a previous network of the convolution neural network, where the previous network comprising an input layer, a convolution computing layer, an activation layer, or a pooling layer.

7. An electronic device comprising:
a storage device;
at least one processor; and
the storage device storing one or more programs, which when executed by the at least one processor, cause the at least one processor to:
output an input matrix of an input image, where the input matrix comprising a plurality of data, each of the plurality of data being an image data of the input image;
slide on the input matrix according to preset convolution kernels to perform dot products to output one or more first output matrixes on a convolution computing layer, each of the first output matrixes comprising feature data of features of the input image; and
perform nonlinear mapping on the one or more first output matrixes according to one or more preset activation functions on an activation layer to output one or more second output matrixes, where each of the preset activation functions being configured to sift feature values of the feature data in one corresponding first output matrix according to a corresponding preset bias value of the convolution neural network, to map the features which satisfy a preset condition onto the second output matrix according to the preset bias value, each of the second output matrix comprising data sifted from the feature data.

8. The electronic device according to claim 7, further causing the at least one processor to:
obtain, for any one convolution kernel of the convolution computing layer, a preset bias value corresponding to the convolution kernel; and
construct a preset activation function for each of the convolution kernels according to the corresponding preset bias value.

9. The electronic device according to claim 8, further causing the at least one processor to:
obtain an original activation function and a threshold corresponding to the original activation function, where the threshold being configured to sift the feature data;
construct new thresholds according to the preset bias values and the threshold;
construct new mapping values according to the preset bias values and mapping values of the original activation function; and
construct the preset activation functions according to the new thresholds and the new mapping values.

10. The electronic device according to claim 9, further causing the at least one processor to:
determine, for any one value in each of the first output matrixes, whether the value is greater than a corresponding new threshold;
map the value to be a total of the value and a corresponding preset bias value if the value is greater than the corresponding new threshold; and
mapping the value to be a smaller value, where the smaller value comprising zero if the value is less than or equal to the corresponding new threshold.

11. The electronic device according to claim 9, wherein:
the original activation function comprises a Relu activation function, where the Relu activation function comprises f(x)=max (0, x), where the threshold being zero, x being a feature value of the feature data, and f(x) being the mapping value.

12. The electronic device according to claim 7, wherein:
the input matrix comprises the matrix output from a previous network of the convolution neural network, where the previous network comprising an input layer, a convolution computing layer, an activation layer, or a pooling layer.

13. A non-transitory storage medium storing a set of commands, when the commands being executed by at least one processor of an electronic device, causing the at least one processor to:
output an input matrix of an input image, where the input matrix comprising a plurality of data, each of the plurality of data being an image data of the input image;
slide on the input matrix according to preset convolution kernels to perform dot products to output one or more first output matrixes on a convolution computing layer, each of the first output matrixes comprising feature data of features of the input image; and
perform nonlinear mapping on the one or more first output matrixes according to one or more preset activation functions on an activation layer to output one or more second output matrixes, where each of the preset activation functions being configured to sift feature values of the feature data in one corresponding first output matrix according to a corresponding preset bias value of the convolution neural network, to map the features which satisfy a preset condition onto the second output matrix according to the preset bias value, each of the second output matrix comprising data sifted from the feature data.

14. The non-transitory storage medium according to claim 13, further causing the at least one processor to:
obtain, for any one convolution kernel of the convolution computing layer, a preset bias value corresponding to the convolution kernel; and
construct a preset activation function for each of the convolution kernels according to the corresponding preset bias value.

15. The non-transitory storage medium according to claim 14, further causing the at least one processor to:
obtain an original activation function and a threshold corresponding to the original activation function, where the threshold being configured to sift the feature data;
construct new thresholds according to the preset bias values and the threshold;
construct new mapping values according to the preset bias values and mapping values of the original activation function; and
construct the preset activation functions according to the new thresholds and the new mapping values.

16. The non-transitory storage medium according to claim 15, further causing the at least one processor to:
determine, for any one value in each of the first output matrixes, whether the value is greater than a corresponding new threshold;
map the value to be a total of the value and a corresponding preset bias value if the value is greater than the corresponding new threshold; and
mapping the value to be a smaller value, where the smaller value comprising zero if the value is less than or equal to the corresponding new threshold.

17. The non-transitory storage medium according to claim 15, wherein:
the original activation function comprises a Relu activation function, where the Relu activation function comprises f(x) =max (0, x), where the threshold being zero, x being a feature value of the feature data, and f(x) being the mapping value.

18. The non-transitory storage medium according to claim 13, wherein:
the input matrix comprises the matrix output from a previous network of the convolution neural network, where the previous network comprising an input layer, a convolution computing layer, an activation layer, or a pooling layer.
